(19) United States
(12) Patent Application Publication
(10) Pub. No.: US 2007/0250651 A1
(43) Pub. Date: Oct. 25, 2007

(54) System and Method of Substituting Redundant Same Address Devices on a Multi-Mastered IIC Bus

(76) Inventors: Douglas M. Boecker, Rochester, MN (US); Nathan D. Miller, Rochester, MN (US); Alwood P. Williams III, Rochester, MN (US)

Correspondence Address: IBM CORPORATION, 3605 HIGHWAY 52 NORTH, DEPT 917, ROCHESTER, MN, 55901-7829, US

(21) Appl. No.: 11/769,505

(22) Filed: Jun. 27, 2007

Related U.S. Application Data
(63) Continuation of application No. 11/290,891, filed on Nov. 30, 2005.

(51) Int. Cl. G06F 13/14

(52) U.S. Cl. 710/107

(57) ABSTRACT

A method, apparatus, and computer-usable medium for coupling a collection of redundant, same-address slave devices via an interconnect. If a substitution among the collection of redundant, same-address slave devices is desired, a determination of whether the activity on the interconnect has become idle is made. If the activity on the interconnect is determined to be idle, access to the interconnect is restricted and the switch between redundant, same-address slave devices is made. After the substitution among the redundant, same-address slave devices has been made, access to the interconnect is released.

### RELATED APPLICATION

The present application is a continuation of U.S. patent application Ser. No. 11/290,891 (Attorney Docket No. ROC920050288US2) filed on Nov. 30, 2005, and entitled “System and Method of Substituting Redundant Same Address Devices of a Multi-Mastered IIC Bus,” which is incorporated herein by reference.

### BACKGROUND OF THE INVENTION

1. Technical Field

The present invention relates in general to the field of data processing systems and similar technologies. More particularly, the present invention relates to a system and method of substituting redundant same address devices on a multi-mastered IIC bus.

2. Description of the Related Art

In today's electronics industry, seemingly unrelated designs often include common features such as a central controller (e.g., microcontroller), general purpose circuits (e.g., drivers and ports for external interfaces), and application-oriented circuits (e.g., digital tuning and signal processing circuits for radio and video systems).

The Inter-IC (IIC) bus specification enables communication between disparate integrated circuit (IC) devices via a two-line bus. The two bus lines typically include a serial data line (SDA) and a serial clock line (SCL). Each device coupled to the bus may be addressed by software utilizing a unique identification address. Also, simple master/slave relationships exist at all times where master devices can act as master-transmitters or master-receivers. A true, multi-master bus also includes collision detection and arbitration schemes to prevent data corruption if two or more master devices simultaneously initiate data transfers over the bus.

Often, a system that utilizes an IIC bus requires redundant device access to the bus. For example, in the event that a first device on the IIC bus fails, a second device assumes the responsibilities of the first device. As well-known by those with skill in the art, standard IIC protocol requires that each device coupled to the IIC bus, including redundant devices, must have a unique identification address. This requirement for a unique address requires that in the event of a first redundant device failure, the rest of the system must be notified of the unique identification address of the second redundant device in order for the system to continue operation. What is desired is “transparent redundancy”, where both the first and second redundant devices have the same identification address. Transparent redundancy does not require the rest of the system to be notified of a new identification address when a second redundant device takes over for a failed first redundant device.

It is also well-known by those with skill in the art that standard IIC protocol limits any design utilizing the IIC bus to have a maximum of one redundant, same identification address device on the IIC bus at a time. Master devices coupled to the IIC bus are typically responsible for substituting (e.g., enabling/disabling) redundant, same identification address devices on the IIC bus. The substitution procedure is typically performed by an IIC bus master device. When a redundant device fails, the failed redundant device is substituted off the IIC bus and the backup redundant device is enabled by the IIC bus master device. While this substitution scheme is applicable to a single master IIC bus system, redundant same address devices may not be substituted successfully at any time on a multi-master bus system since the substitution of the devices may interfere with the communications initiated by other master devices on the bus.

Therefore, there is a need for system and method of substituting redundant same address devices on a multi-mastered IIC bus to enable transparent redundancy.

### SUMMARY OF THE INVENTION

The present invention includes, but is not limited to, a method, apparatus, and computer-usable medium for coupling a collection of redundant, same-address slave devices via an interconnect. If a substitution among the collection of redundant, same-address slave devices is desired, a determination of whether the activity on the interconnect has become idle is made. If the activity on the interconnect is determined to be idle, access to the interconnect is restricted and the switch between redundant, same-address slave devices is made. After the substitution among the redundant, same-address slave devices has been made, access to the interconnect is released.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, wherein:

FIG. 1 is a pictorial illustration of an exemplary computer in which a preferred embodiment of the present invention may be implemented;

FIG. 2 illustrates a block diagram of an exemplary data processing system in which a preferred embodiment of the present invention may be implemented;

FIG. 3 depicts more detailed diagram of exemplary IIC physical devices and IIC bus in which a preferred embodiment of the present invention may be implemented; and

FIG. 4A-B are high-level logical flowchart diagrams illustrating two exemplary methods of substituting redundant same address devices on a multi-mastered IIC bus according to a preferred embodiment of the present invention.

### DETAILED DESCRIPTION OF THE PREFERRED EMBODIMENT

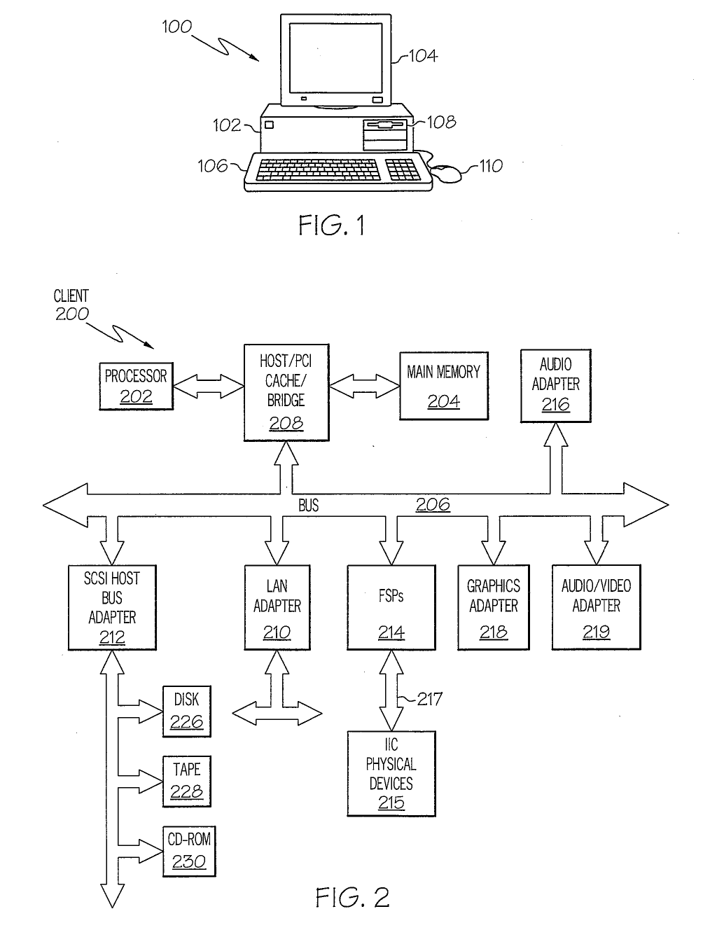

With reference now to the figures, and in particular, with reference to FIG. 1, there is depicted a pictorial representation of a data process system in which the present invention may be implemented according to a preferred embodiment. A computer 100 is depicted which includes system unit 102, video display terminal 104, keyboard 106, storage devices 108, which may include floppy drives and other types of permanent and removable storage media, and mouse 110. Additional input devices may be included with computer 100, such as, for example, a joystick, touchpad, touch screen, trackball, microphone, and the like. Computer 100 can be implemented utilizing any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

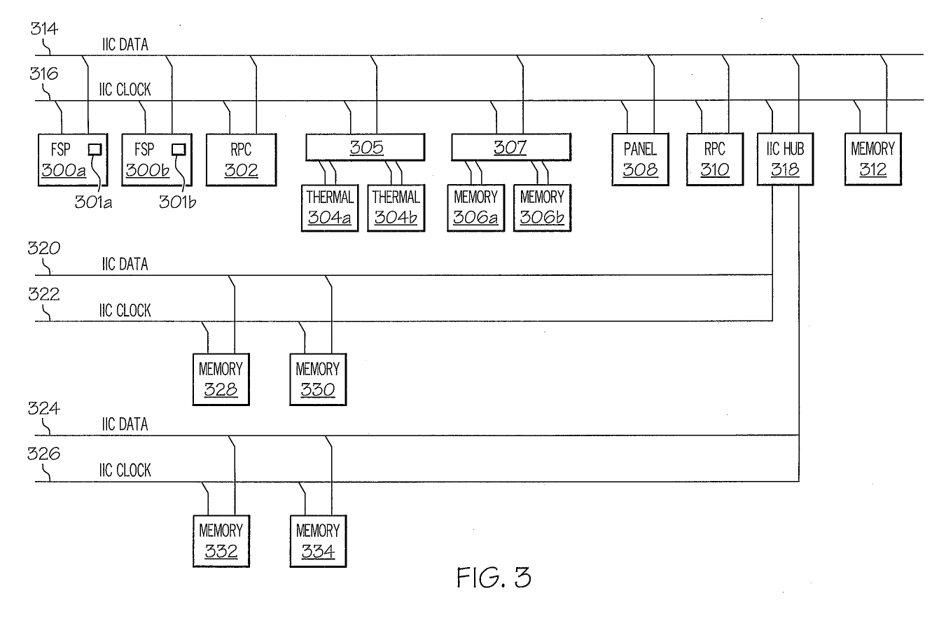

With reference now to FIG. 2, a block diagram of a data processing system is shown in which a preferred embodiment of the present invention may be implemented. Data processing system 200 is an example of a computer, such as computer 100 illustrated in FIG. 1, in which code or instructions implementing the processes of the present invention may be located. Data processing system 200 employs a peripheral component interconnect (PCI) local bus architecture; however, other bus architectures, such as Accelerated Graphics Port (AGP) and Industry Standard Architecture (ISA) may be used. Processor 202 and main memory 204 are coupled to PCI local bus 206 through PCI bridge 208. PCI bridge 208 also may include an integrated memory controller and cache memory for processor 202. Additional connections to PCI local bus 206 may be made through direct component interconnection. In the depicted example, local area network (LAN) adapter 210, small computer system interface (SCSI) host bus adapter 212, and flexible service processors 214 are connected to PCI local bus 206 by direct component connection. In contrast, audio adapter 216, graphics adapter 218, and audio/video adapter 219 are connected to PCI local bus 206 by add-in boards inserted into expansion slots.

Flexible service processors 214 provide PCI and IIC bus connections. In this example, flexible service processors 214 are connected to inter-integrated circuit physical devices 215 by IIC bus 217. Inter-integrated circuit (IIC) physical devices 215 include components, such as a control panel, a flexible service processor, a power device, and a memory.

SCSI host bus adapter 212 provides a connection for hard disk drive 226, tape drive 228, and CD-ROM drive 230. PCI local bus implementations will preferably support three or four PCI expansion slots or add-in connectors.

An operating system runs on processor 202 and is utilized to coordinate and provide control of various components within data processing system 200 of FIG. 2. The operating system may be a commercially available operating system such as Windows XP, which is available from Microsoft Corporation. Instructions for the operating system and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, or the like. As another example, data processing system 200 may be a stand-alone system configured to be bootable without relying on some type of network communication interface, whether or not data processing system 200 includes some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a personal data assistant (PDA). Data processing system 200 also may be a kiosk or a Web appliance.

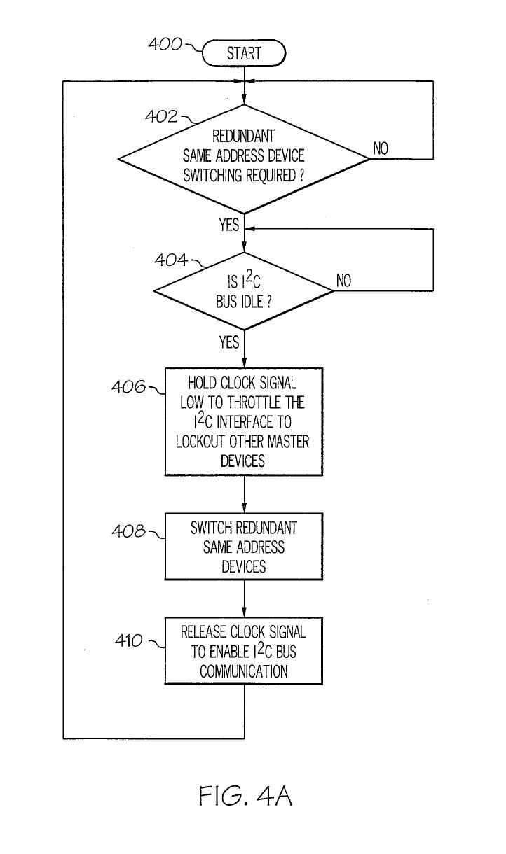

Referring now to FIG. 3, there is illustrated a diagram depicting physical devices utilized in transferring data is depicted in accordance with a preferred embodiment of the present invention. The physical devices illustrated in FIG. 3 are similar to IIC physical devices 215 in FIG. 2.

In this example, flexible service processors (FSP) 300a-b (including logical switches 301a-b), rack power controller (RPC) 302, thermal units 304a-b (coupled by switch 305), memory 306a-b (coupled by switch 307), panel 308, rack power controller 310, and memory 312 are coupled to primary IIC bus, which is formed by data line 314 and clock line 316. IIC hub 318 is also coupled to data line 314 and clock line 316. This hub provides an interconnection for two additional IIC buses formed by data line 320, clock line 322, data line 324, and clock line 326 in this example. Memory 328 and memory 330 are coupled to data line 320 and clock line 322. Memory 332 and memory 334 are coupled to data line 324 and clock line 326.

As illustrated, flexible service processors 300a-b are physical devices that execute an operating system and are initialized prior to initialing the rest of the data processing system. Flexible service processors 300a-b includes components, such as nonvolatile memory, a flash memory, and a controller to control various I/O devices. Rack power controller 302 and 310 are physical devices that provide control functions for power to a data processing system. Thermal units 304a-b are physical devices providing temperature data. Panel 308 is a physical device, such as a panel with a power or reset button. Memory 306a-b, memory 312, memory 328, memory 330, memory 332, and memory 334 are utilized to store data. According to a preferred embodiment of the present invention, flexible service processors 300a-b, rack power controllers 302 and 310, and panel 308 are implemented as master devices. As well known to those with skill in the art, master devices can also be accessed as slave devices by other masters. Accordingly, all devices depicted in FIG. 3 can be accessed as slave devices.

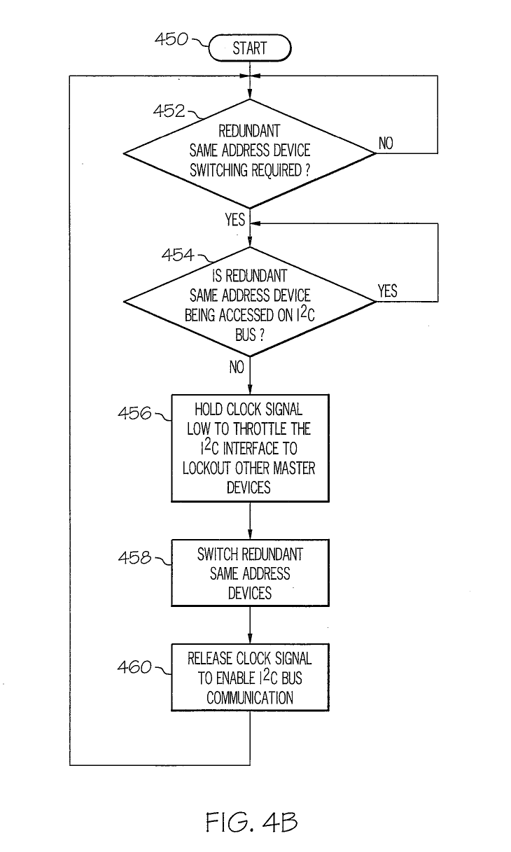

Still referring to FIG. 3, rack power controllers 302 and 310 are implemented as redundant, different address devices. As previously discussed, it is well-known to those with skill in the art to implement redundant, different address devices (e.g., rack power controllers 302 and 310). Both rack power controllers 302 and 310 have different, unique identification address, and are both monitored by a master device, such as flexible service processor 300a, where one rack power controller takes over the responsibilities of the other in the event of a failover or substituted over due to administrative purposes (e.g., scheduled maintenance). Those with skill in the art will appreciate that another implementation of redundant, different address devices may include notifying the rest of the system of a a change in the unique identification address if, for example, rack power controller 310 takes over for rack power controller 302. Accordingly, flexible service processors 300a-b, thermal units 304a-b, and memory 306a-b are implemented as redundant, same address devices, as discussed in more detail in conjunction with FIGS. 4A-B.

Those with skill in the art will appreciate that a preferred embodiment of the present invention may implement a variety of substitution schemes to substitute between redundant, same address devices. For example, flexible service processors 300a-b utilize logical switches 301a-b to facilitate redundant, same address device substitution. Since flexible service processors 300a-b are directly wired to IIC data and clock lines 314 and 316, substituting between flexible service processors 300a-b is accomplished by disabling the IIC interface in a first flexible service processor (e.g., flexible service processor 300a) and enabling the IIC interface in a second, redundant, same address flexible service processor (e.g., flexible service processor 300b). Since there is no electrical/physical disconnection, flexible service processors 300a-b must coordinate the disabling of the first flexible service processor and the enabling of the second (replacement) flexible service processor to avoid a situation where both flexible service processors are active at the same time and utilizing the same identification address.

Thermal units 304a-b and memory 306a-b are coupled to physical switches 305 and 307. Physical switches 305 and 307 are preferably implemented as a multiplexor, general purpose input/output (GPIO) switch, or any other type of physical switch that enables a physical disconnection of one device and the physical connection of the redundant same address device. For example, if flexible service processor 300a determines that thermal unit 304a is not functioning correctly, flexible service processor 300a directs physical switch 305 to disconnect thermal unit 304a and enable thermal unit 304b.

In a preferred embodiment of the present invention, there may be a variety of reasons to enable and disable redundant, same address devices. As previously described, if a first device fails, a second device may be substituted to take over the responsibilities of the failed first device. Also, substitution may be accomplished for administrative purposes. An example of an administrative purpose would be to verify and/or test the standby redundant, same address hardware for functionality.

As previously discussed, the IIC bus specification enables communications between integrated circuit devices via a two-line bus, illustrated in FIG. 3 as IIC data line 314 and IIC clock line 316. The clock signal utilized over IIC clock line 316 is dictated by the transmitting master device. The IIC bus is determined to be “free” or “idle” when any IIC start condition includes a matching IIC stop condition.

In a preferred embodiment of the present invention, an IIC start condition occurs when IIC data line 314 transitions from a HIGH to LOW state when IIC clock line 316 is in a HIGH state. An IIC stop condition occurs when IIC data line 314 transitions from a LOW to a HIGH state when IIC clock line 316 is in a HIGH state.

Data transmitted via IIC data line 314 is valid only when IIC clock line 316 is in the HIGH state. The master device can prevent all other master device from accessing the IIC bus by holding IIC clock line 316 in the LOW state (e.g., any data sent over IIC data line 314 is not valid when IIC clock line 316 is LOW).

FIG. 4A is a high-level logical flowchart illustrating a first preferred embodiment of substituting redundant same address devices on a multi-mastered IIC bus according to a preferred embodiment of the present invention. The process begins at step 400 and proceeds to step 402, which illustrates a master device (e.g., flexible service processor 300a, rack power controllers 302 and 310, or panel 308) determining that a device implemented as a redundant, same-address requires substitution. In a preferred embodiment of the present invention, the substitution determination may be implemented by any active or passive error detection method, or a combination of both. For example, the master device may periodically query the slave device to determine if the device is responding. If the slave device does not respond to a predetermined number of queries or after a predetermined amount of time, the master device may determine that a substitution of the slave device is required. Also, the master device may determine that a slave device is inoperable through a message reporting the error from a different device on the system.

If the master device determines that redundant, same-address device substitution is not required, the process iterates at step 402. If the master device determines that redundant, same-address device substitution is required, the process proceeds to step 404, which illustrates the master device determining if the IIC bus is idle (e.g., each IIC start condition includes a matching IIC stop condition). If the IIC bus is not idle, the process iterates at step 404. If the IIC bus is determined to be idle, the process continues to step 406, which depicts the master device by forcing a HIGH to LOW transition of IIC clock line 316 to prevent other master devices from accessing the IIC bus.

The process proceeds to step 408, which illustrates the master device substituting a first redundant, same-address device for a second redundant, same-address device. The process continues to step 410, which depicts the master device releasing IIC clock line 316 and enabling IIC bus the idle state (e.g., each IIC start condition includes a matching IIC stop condition). The process returns to step 402 and proceeds in an iterative fashion.

For example, flexible service processor 300a may determine that memory 306a is not responding due to a failure. In order to continue servicing requests to that memory location, flexible service processor 300a determines that memory 306a must be replaced by memory 306b, a redundant, same-address device. Flexible service processor 300a waits for the IIC bus to be idle and then forces IIC clock line 316 to LOW to prevent any other master devices from accessing the bus. Flexible service processor 300a then substitutes memory 306a and memory 306b, which enables memory 306b to take over the responsibilities of memory 306a. Flexible service processor 300a releases control of IIC clock line 316 and allows the clock line to transition from LOW to HIGH, which restores the IIC bus's operational state, which enables another master device to take control of the IIC bus.

FIG. 4B is a high-level logical flowchart illustrating a second preferred embodiment of substituting redundant same address devices on a multi-mastered IIC bus according to a preferred embodiment of the present invention. In this second preferred embodiment, the redundant, same-address slave devices may be substituted by a master device at any time the slave devices are not being addressed.

The process begins at step 450 and proceeds to step 452, which illustrates a master device (e.g., flexible service processor 300a, rack power controllers 302 and 310, or panel 308) determining that a device implemented as a redundant, same-address requires substitution. In a preferred embodiment of the present invention, the substitution determination may be implemented by any active or passive error detection method, or a combination of both. For example, the master device may periodically query the slave device to determine if the device is responding. If the slave device does not respond to a predetermined number of queries or after a predetermined amount of time, the master device may determine that a substitution of the slave device is required. Also, the master device may determine that a slave device is inoperable through a message reporting the error from a different device on the system.

If the master device determines that redundant, same-address device substitution is not required, the process iterates at step 452. If the master device determines that redundant, same-address device substitution is required, the process proceeds to step 454, which illustrates the master device determining if the redundant, same address device to be substituted is being addressed. If the redundant, same-address device to be substituted is being addressed (e.g., by another master device), the process iterates at step 454. If the redundant, same-address device to be substituted is not being addressed, the process continues to step 456, which depicts the master device by forcing a HIGH to LOW transition of IIC clock line 316 to prevent other master devices from accessing the IIC bus.

The process proceeds to step 458, which illustrates the master device substituting a first redundant, same-address device for a second redundant, same-address device. The process continues to step 460, which depicts the master device releasing IIC clock line 316 and enabling IIC bus to return to the operational state where other masters can then take control of the communication over the IIC bus. The process returns to step 452 and proceeds in an iterative fashion.

For example, flexible service processor 300a may determine that memory 306a is not responding due to a failure. In order to continue servicing requests to that memory location, flexible service processor 300a determines that memory 306a must be replaced by memory 306b, a redundant, same-address device. Flexible service processor 300a waits for memory 306a to be idle and then forces IIC clock line 316 to LOW to prevent any other master devices from accessing the bus. Flexible service processor 300a then substitutes memory 306a and memory 306b, which enables memory 306b to take over the responsibilities of memory 306a. Flexible service processor 300a releases control of IIC clock line 316.

The present invention includes, but is not limited to, a method, apparatus, and computer-usable medium for coupling a collection of redundant, same-address slave devices via an interconnect. If a substitution among the collection of redundant, same-address slave devices is desired, a determination of whether the activity on the interconnect has become idle is made. If the activity on the interconnect is determined to be idle, access to the interconnect is restricted and the substitution between redundant, same-address slave devices is made. After the substitution among the redundant, same-address slave devices is made, access to the interconnect is released.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, Personal Digital Assistants (PDAs), telephones, and any other system capable of processing, transmitting, receiving, capturing, and/or storing data.

It should be understood that at least some aspects of the present invention may alternatively be implemented in a computer-usable medium that contains a program product. Programs defining functions of the present invention can be delivered by a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet, the Internet, wireless networks, and like network systems. It should be understood, therefore, that such signal-bearing media when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

What is claimed is:

1. A method comprising:
coupling a plurality of redundant slave devices via an interconnect;
coupling a plurality of master devices via said interconnect;
in response to determining a substitution among said plurality of redundant, same address slave devices is desired, determining if activity on said interconnect has become idle;
in response to determining said activity on said interconnect has become idle, a first master device among said plurality of master devices restricting access to said interconnect by other master devices among said plurality of master devices;
in response to restricting access to said interconnect by said other master devices among said plurality of master devices, said first master device performing said substitution among said plurality of redundant, same address slave devices; and
in response to completing said substitution, said first master device releasing access to said interconnect by said other master devices among said plurality of master devices.

2. The method according to claim 1, wherein said determining if activity on said interconnect has become idle further comprises:
detecting a stop condition on said interconnect that corresponds to a start condition on said interconnect.

3. The method according to claim 2, wherein said interconnect further includes a data line and a clock line, said detecting further comprises:
detecting a start condition on said interconnect, wherein said start condition includes a HIGH-to-LOW state transition on said data line while said clock line is in a HIGH state; and
in response to detecting said stop condition, detecting a stop condition corresponding to said start condition, wherein said start condition includes a LOW-to-HIGH state transition on said data line while said clock line is in said HIGH state.

4. The method according to claim 1, wherein said interconnect further includes a data line and a clock line, said restricting access further comprises:
holding said clock line in a LOW state.

5. The method according to claim 1, further comprising:
determining if at least one slave device to be substituted among said plurality of redundant, same address slave devices is being accessed by at least one master device among said plurality of master devices, waiting for said access at least one slave device among said plurality of redundant, same address slave devices to complete.

6. A system comprising:
a processor;
a system interconnect coupled to said processor;
a plurality of redundant, same-address devices coupled to a device interconnect; and
a plurality of master devices coupled to said device interconnect further including:
a first master device for performing a substitution among said plurality of redundant, same address slave devices after determining activity on said device interconnect is idle and restricting access to said device interconnect from other master devices among said plurality of master devices.

7. The system according to claim 6, wherein said activity on said device interconnect is idle once a stop condition on said interconnect that corresponds to a start condition on said interconnect is detected by said first master device.

8. The system according to claim 7, wherein said device interconnect further includes a data line and a clock line, wherein said start condition includes a HIGH-to-LOW state transition on said data line while said clock line is in a HIGH state; and wherein said start condition includes a LOW-to-HIGH state transition on said data line while said clock line is in said HIGH state.

9. The system according to claim 6, wherein said device interconnect further includes a data line and a clock line, and wherein said first master device restricts access to said device interconnect by holding said clock line in a LOW state.

10. The system according to claim 6, wherein said first master device determines if at least one slave substituted among said plurality of redundant, same address slave devices is being accessed by at least one master device of said plurality of master devices and waits for said access to said at least one slave device among said plurality of redundant, same address slave devices to complete.

11. A computer-usable storage medium embodying computer program code, said computer program code comprising computer executable instructions configured for:
coupling a plurality of redundant, same-address slave devices via said interconnect;
coupling a plurality of master devices via said interconnect;
in response to determining a substitution among said plurality of redundant, same address slave devices is desired, determining if activity on said interconnect has become idle;
in response to determining said activity on said interconnect has become idle, a first master device among said plurality of master devices restricting access to said interconnect by other master devices among said plurality of master devices;
in response to restricting access to said interconnect by said other master devices among said plurality of master devices, said first master device performing said substitution among said plurality of redundant, same address slave devices; and
in response to completing said substitution, said first master device releasing access to said interconnect by said other master devices among said plurality of master devices.

12. The computer-usable storage medium according to claim 11, wherein said embodied computer program code for determining if activity on said interconnect has become idle further comprises computer executable instructions configured for:
detecting a stop condition on said interconnect that corresponds to a start condition on said interconnect.

13. The computer-usable storage medium according to claim 12, wherein said interconnect further includes a data line and a clock line, wherein said embodied computer program code for detecting further comprises computer executable instructions configured for:
detecting a start condition on said interconnect, wherein said start condition includes a HIGH-to-LOW state transition on said data line while said clock line is in a HIGH state; and
in response to detecting said stop condition, detecting a stop condition corresponding to said start condition, wherein said start condition includes a LOW-to-HIGH state transition on said data line while said clock line is in said HIGH state.

14. The computer-usable storage medium according to claim 11, wherein said interconnect further includes a data line and a clock line, wherein said embodied computer program code for restricting access further comprises computer executable instructions configured for:
holding said clock line in a LOW state.

15. The computer-usable storage medium according to claim 11, wherein said embodied computer program code further comprises computer executable instructions configured for:
determining if at least one slave substituted among said plurality of redundant, same address slave devices is being accessed by at least one master device among said plurality of master devices, waiting for said access to said at least one slave device among said plurality of redundant, same address slave devices to complete.
